(19) United States
(12) Patent Application Publication
(10) Pub. No.: US 2008/0022878 A1
(43) Pub. Date: Jan. 31, 2008

(54) Methods for applying decorative images on trash receptacle liners

(76) Inventor: Gary T. Petler, Silvana, WA (US)

Correspondence Address: Gary T. Petler, P.O. Box 102, Silvana, WA, 98287-0102, US

(21) Appl. No.: 11/495,005

(22) Filed: Jul. 29, 2006

(51) Int. Cl. B41F 33/00

(52) U.S. Cl. 101/483

(57) ABSTRACT

The objective of the invention is to provide a new and improved appearance and claimed multiple methods for applying image applications to a trash receptacle liner, such as lettering, borders, images, scenes and shapes, employing various method image application procedures as herein claimed. The new decorative trash receptacle liner provides further creative and innovation that will add to the decor, thus providing the viewer a more pleasant and appealing appearance as well as a new visual decorative addition to the public domain. The new claimed decorative trash receptacle liner methodology application images clearly provides for visual images adding to an otherwise drab product. The diagram describes the invention in the visual, leaving no question as to the uniqueness of the invention and of obvious practical use, a aesthetic inventive contribution to the seemingly blank trash receptacle liner.

### BRIEF DESCRIPTION OF DRAWINGS

### FIGURE DESCRIPTIONS

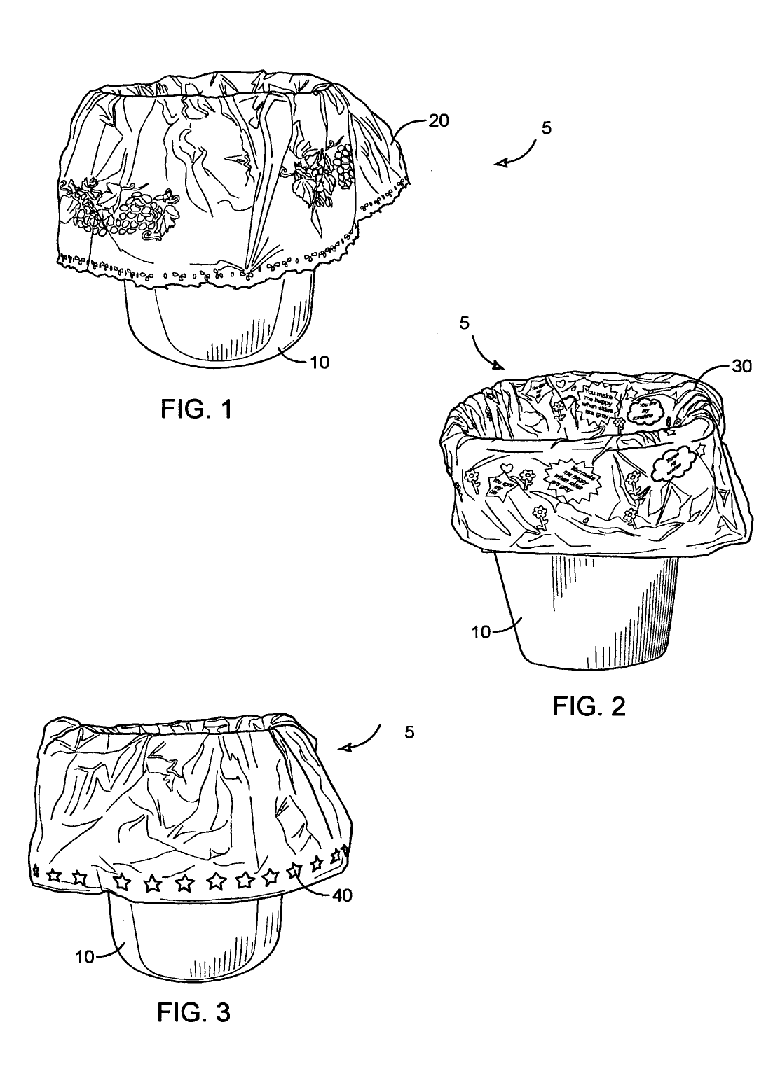

FIG. 1 is a perspective view of the invention, illustrating a first preferred embodiment decorative appearance to the usual commonplace mundane trash receptacle liner. Added decorative appearance such as lettering, borders, images, scenes and shapes utilizing the claimed image applications as herein described. View showing my new design;

FIG. 2 is a perspective view of a second preferred embodiment decorative trash liner: and view thereof;

FIG. 3 is a perspective view of a third embodiment decorative trash receptacle liner decorative trash liner utilizing the claimed image applications as herein described view thereof;

### NUMBER DESCRIPTION LIST

5 is a trash receptacle with decorative receptacle liner of the invention.

10 is a trash receptacle.

20 is a liner with images.

30 is a liner with images and text.

40 is a liner border.

What is claimed is:

1. I claim the following Methods for Applying Decorative Images and Designs on Trash Receptacle Liners, before, during or after manufacturing.

2. The device as set forth in claim one, further comprising and employing a design process image application in the form of cutting shapes and images into one or several layers at a time to trash receptacle liners before, during or after manufacturing, by means of pressing a sharp knife edge in the form of a steel rule die, also known as die-cutting with various tooled images and shapes to the trash receptacle liner, thus, cutting of flat sheet or multiple sheets to design image shape by striking it with a mating die. The pressure to employ the image shapes is applied by any one or combination of hydraulic, electrical or mechanical process, thus causing an application of a design or image to the trash receptacle liner.

3. The device as set forth in claim one, further comprising and employing a stamped design image application utilizing pressure by any on or combination of hydraulic, electrical or mechanical process, thus, creating a flat image indentation impression image indentation to the trash receptacle liner with design image either before, during or after manufacturing.

4. The device as set forth in claim one, further comprising and employing a design image process application in the form of a ink printed image utilizing a printed impression of a text greeting or expressing phrasal verbs in printed form, utilizing a device or implement to apply text lettering in impressions in black or color ink transferred from a engraved plate or other printing medium by pressure, thus, causing a printed image to the trash receptacle liner, before, during or after manufacturing.

5. The device as set forth in claim one, further comprising and employing the process of a photographic image or design in black or color images, to include silhouettes and photo montages transferred from a plate or other medium by transfer, thus, causing a photographic applied image to the trash receptacle liner, before, during or after manufacturing.

6. The device as set forth in claim one, further comprising and employing a design image application by the process of applique, by employing decorated or ornamental pieces of material, applied to the trash receptacle liner by a method of adhesion (glue), either in black or color image, thus, causing images on the trash receptacle liner, before, during or after manufacturing.

7. The device as set forth in claim one, further comprising and employing a design image application process of a Silk Screened image application, also referred to as stenciled, utilizing a method of printmaking with a image or design imposed on a template or screen mesh, with blank areas, the ink being forced through to the trash liner surface, either a black or color image, to the trash receptacle liner, before, during or after manufacturing.

8. The device as set forth in claim one, further comprising and employing a process design image application by means of thermal heat, thus, utilizing a template with a image design employing images and design, which when template is thermal heated, will transfer image to the surface of the trash receptacle liner, before, during or after manufacturing.

9. The device as set forth in claim one, further comprising and employing a process design image application by means of imbedding image designs also know as laminated within the trash liner stock before or during manufacturing process, thus, employing images and designs between layers of the trash receptacle liner.

10. The device as set forth in claim one, further comprising and employing a process of design image application by means of utilizing the method of computer programed laser cut image designs to the trash receptacle liner before, during or after manufacturing.

11. The device as set forth in claim one, further comprising and employing a method of chemical etching image design by means of chemical etching, utilizing a acid formed design image, thus, causing a image to trash receptacle liner, before or during manufacturing.

12. The device as set forth in claim one, further comprising and employing a raised embossed surface design image application utilizing the mechanics of pressure by any one or combination of hydraulic, electrical or mechanical process, thus, causing a raised embossed impression image to the trash receptacle liner, before, during or after manufacturing.
